(19) United States
(12) Patent Application Publication
(10) Pub. No.: US 2025/0027962 A1
(43) Pub. Date: Jan. 23, 2025

(54) LABORATORY SYSTEM WITH INCREASED CONTROLS HANDLING AND METHOD FOR INCREASING CONTROLS HANDLING IN A LABORATORY SYSTEM OR DEVICE

(71) Applicant: Roche Molecular Systems, Inc., Pleasanton, CA (US)

(72) Inventors: William Joseph Cobb, Rotkreuz (CH); Alan Furlan, Lucerne (CH); Andreas Gisler, Zurich (CH); Martin Horat, Schwyz (CH); Michèle Knaus, Zurich (CH); Raymond Minder, Lucerne (CH)

(21) Appl. No.: 18/711,375

(22) PCT Filed: Nov. 16, 2022
(86) PCT No.: PCT/EP2022/082077

§ 371 Date: May 17, 2024

(30) Foreign Application Priority Data
Nov. 18, 2021 (EP) 21209087.2

(51) Int. Cl. G01N 35/00

(52) U.S. Cl. CPC G01N 35/0092; G01N 35/00594; G01N 35/00722

(57) ABSTRACT

A laboratory system or device comprising a control unit for controlling operation of the system or device, and a storage unit connected to the control unit and containing instruction for each assay type of the control type to be used when running said assay type, and, for each control type, an allocation rule for the control type. The control unit receiving at least one assay order comprising instructions to run at least one assay type on the system or device, determining for the at least one assay type comprised in the at least one assay order, the control type to be used, and the corresponding allocation rule for said control type, scheduling an assay run comprising instructions to include the determined control type based on the determined allocation rule, and controlling the system or device to perform the scheduled assay run.

### FIELD OF THE INVENTION

The invention relates to a laboratory system or device with increased controls handling, to method for increasing control handling in a laboratory system or device, to a computer program product and to a computer readable medium.

### BACKGROUND

Positive and negative controls are used verify the integrity and functionality of assay and reagents in laboratory system and devices. Positive controls are controls that contain an analyte of interest and are used to check if the assay or reagents used are working as expected. The results of a positive control is expected to be a positive result, meaning that the analyte of interest has been detected. Negative controls are controls that do not contain the analyte of interest and are used to check if the assay or reagents used or if the system or device works properly. The result of a negative control is expected to be negative. A positive result of a negative control would mean, inter alia, that a contamination has occurred. The controls are generally run separately from the sample on system or device. Since the controls, and in particular the positive controls, are very expensive there is the wish to flexibly adapt the frequency of controls used.

It is therefore aim of the present invention to provide a laboratory system or device with increased an optimized controls handling and to provide a method for increasing and optimizing controls handling in a laboratory system or device.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In the method for increasing and optimizing controls handling in a laboratory system or device, the system or device comprises a control unit for controlling operation of the system or device, and a storage unit connected to the control unit. The control unit may be a dedicated control unit for this specific purpose, but is preferably integrated in a control unit for controlling other functions of the system or device. The control unit may be located in the system or device or may be implemented as a server or cloud based control unit.

The storage unit contains, for each assay type, at least instruction of the control type to be used when running said assay type, and, for each control type, an allocation rule for the control type.

For each assay type that is allowed to be performed on the system or device, there is therefore associated a control type to be used for the specific assay type, e.g. a positive control and a negative control, and also an allocation rule for the specific control type. The allocation rule comprises instruction on when and under which decision parameters the associated control type has to be scheduled in a run of the system or device.

In a first step, the control unit receives at least one assay order comprising instructions to run at least one assay type on the system or device. The assay order may be received from an external system or device connected to the control unit, e.g. a LIS, but can also be generated by the control unit itself. Of course, the system or device is configured to perform additional task to ensure that the assay order can be fulfilled, such as checking the availability of all the necessary materials, reagents, controls and samples. For sake of simplicity, it is assumed in the present explanation that the system or device is able to fulfill the received assay order(s). The assay order can comprise instructions to run one or more assay type(s). In order to increase the throughput of the system or device, it is advantageous to process the maximum amount of tests in a run. Since in modern laboratory systems or devices, processing takes place on multiwell plates, optimization of controls handling does not only allow to reduce the costs per test, but also to free up space on the multiwell plate to allow for even more tests to be performed in a run.

The control unit then determines, for the at least one assay type comprised in the at least one assay order, the control type to be used, and the corresponding allocation rule for said control type. In other words, the control unit determines based on the control type associated with the assay type, which control(s) have to be included in a run and, based on the allocation rule associated with the assay type, when and if the control type(s) have to be included in a run.

The control unit then schedules an assay run, the assay run comprising instructions to include the determined control type based on the determined allocation rule. The control unit, after determining based on the control type associated with the assay type, which control(s) have to be included in a run and, based on the allocation rule associated with the assay type, when and if the control type(s) have to be included in a run, schedules the assay run comprising instructions to include said control types that have been determined as necessary for the assay run.

Finally, the control unit controls the system or device to perform the scheduled assay run including the control types that have been scheduled in the previous step.

In a preferred embodiment, the control types associated with an assay type are at least one selected from a positive control type and a negative control type. In a more preferred embodiment, both positive control type and negative control type are associated with an assay type. Of course other control types may be included, such as control types that have been already processed and are added to the multiwell plate in a later stage of the process.

In particular, according to a preferred embodiment, the allocation rule comprises a time rule or a run rule. The time rule hereby comprises at least instructions to run the control type once in a time frame. The time frame defines the maximum amount of time that may elapse between the use of the control type associated with an assay type. In other words, the time rule defines how often the associated control type has to be run for a particular assay type.

The run rule hereby comprises instructions to run the control type once for every assay run, and/or once for every reagent cartridge firstly used in the system or device and/or once for every reagent cartridge lot firstly used in the system or device. The system or device has, as already cited, knowledge of the reagent cartridges loaded therein. According to this embodiment, the control unit determines according to the run rule associated with the assay type, if the reagent cartridge and/or if the reagent cartridge lot (which can be determined over an ID of the reagent cartridge) for the specific assay type have been already used in the system or instrument. In case of the run rule for every assay run, the control types associated with an assay type are included in every assay run where the assay type is performed.

In a preferred embodiment, the time rule further comprises instructions to run the control type once for every assay run, and/or once for every reagent cartridge firstly used in the system or device, and/or once for every reagent cartridge lot firstly used in the system or device. Therefore, the run rule cited above is integrated in the time rule, allowing to set multiple dependencies for the use of the different control types associated with an assay type.

Preferably, the run rule comprising instruction to run the control type once for every reagent cartridge lot firstly used in the system or device is always applied by the method and cannot be overrun. In a particular preferred embodiment, both the run rule comprising instruction to run the control type once for every reagent cartridge firstly used in the system or device and the run rule comprising instruction to run the control type once for every reagent cartridge lot firstly used in the system or device are always applied.

In a preferred embodiment, the control unit is further configured to determine an estimated end time of the scheduled run. This task can be easily performed by the control unit with estimated times for the different process steps of the assay run that are provided in a storage connected with the control unit and may be updated based on actual performance of the device.

The control unit then determines in a lifetime determination if the estimated end time of the scheduled run lies outside of the time frame of the time rule. The lifetime determination is therefore a step where it is determined if the estimated end time of the scheduled run lies outside of the time frame of the time rule.

As cited above, the time frame of the time rule defines the maximum amount of time that may elapse between the use of the control type associated with an assay type.

If said lifetime determination is successful, meaning that the estimated end time is later than the ending of the time frame of the time rule, the control unit then reschedules the assay run comprising updated instructions to include the determined control type for which lifetime determination has been determined as successful. Therefore, it is guaranteed that the control type associated with the assay type is still valid when the assay run is terminated.

In a preferred embodiment, the time frame comprises a minimum time frame duration and a maximum time frame duration. Therefore, the time frame can only be defined within the minimum and maximum time frame duration.

The maximum time frame is in particular advantageous if some regulatory or legal aspects have to be considered when handling the different control types. It can be exemplarily requested that, notwithstanding the allocation rules provided, the time frame should be, e.g. 72 hours. In such a case, the maximum time frame is preferably predetermined, meaning that the duration is set to e.g. 72 hours and cannot be changed (set higher) by a user.

The minimum time frame is in particular advantageous for avoiding that the time frame is set to a value which is lower than the general duration of an assay run, while otherwise this would possibly case conflicts with the lifetime determination described before.

Preferably the minimum time frame is preferably predetermined, meaning that the duration is set to e.g. 4 hours and cannot be changed (set lower) by a user.

The control unit is, in a preferred embodiment, further configured to receive an allocation rule over a user interface of the control unit. Preferably, the allocation rule may be selected by a user over a user interface, e.g. a GUI, independently for each control type associated with an assay type. However, it is also possible to configure the control unit such that the allocation rule may only be the same for all control types associated with an assay type. Alternatively, some assay types may not allow the change the allocation rule. In addition, the control unit may determine if the user credentials of the user are valid for changing the allocation rules.

The above description of a method according to the present invention applies accordingly to a system or device, a computer implemented method and a computer storage media according to the present invention.

### SHORT DESCRIPTION OF THE FIGURES

FIG. 1 depicts a possible implementation of the method according to the present invention, and

FIG. 2 depicts a possible GUI for selecting the allocation rules of the present invention.

### DETAILED DESCRIPTION OF THE FIGURES

The invention will be described now by way of preferred embodiments in connection with the drawings.

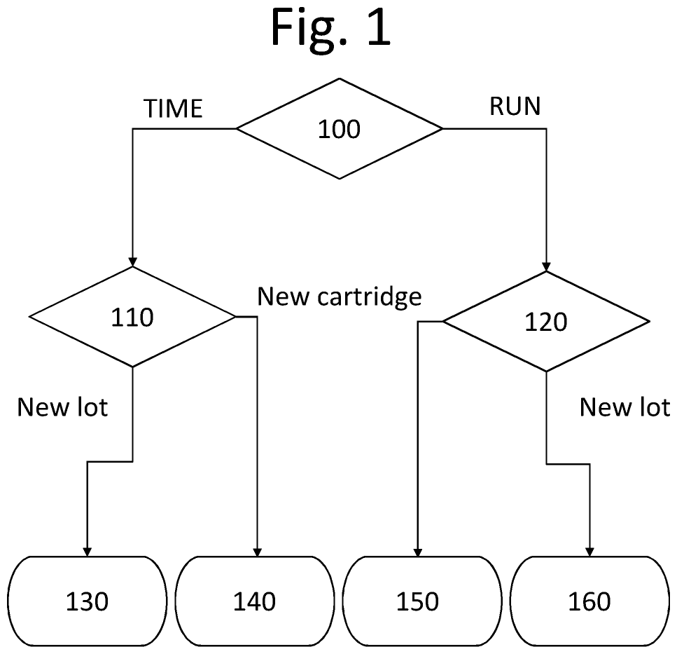

In FIG. 1, a possible implementation of the allocation rules decision is shown. In a first step 100, it can be selected if the allocation rule should comprise a time rule or a run rule. If it is decided that a time rule (TIME) will be the allocation rule for a specific assay type, then a next step 110 is performed. If it is decided that the a run rule (RUN) will be the allocation rule for a specific assay type, then a next step 120 is performed.

Steps 110 and 120 are basically the same, since they comprise the decision if the time or run rule should also comprises instructions to run the control type for every reagent cartridge firstly used in the system or device or once for every reagent cartridge lot firstly used in the system or device. If a time rule should be used and the time rule should also comprise instructions to run the control type for every reagent cartridge lot (new lot) firstly used in the system or device, then the allocation rule configuration 130 is created and stored in the storage unit as allocation rule for the specific assay type. Analogously, if a time rule should be used and the time rule should also comprise instructions to run the control type for every reagent cartridge (new cartridge) firstly used in the system or device, then the allocation rule configuration 140 is created and stored in the storage unit as allocation rule for the specific assay type.

Analogously, if a run rule should be used and the run rule should also comprise instructions to run the control type for every reagent cartridge (new cartridge) firstly used in the system or device, then the allocation rule configuration 150 is created and stored in the storage unit as allocation rule for the specific assay type.

Analogously, if a run rule should be used and the run rule should also comprise instructions to run the control type for every reagent cartridge lot (new lot) firstly used in the system or device, then the allocation rule configuration 160 is created and stored in the storage unit as allocation rule for the specific assay type.

Therefore, the control unit can retrieve from the storage unit the necessary allocation rules associated with assay types of the assay order when the assay order is received.

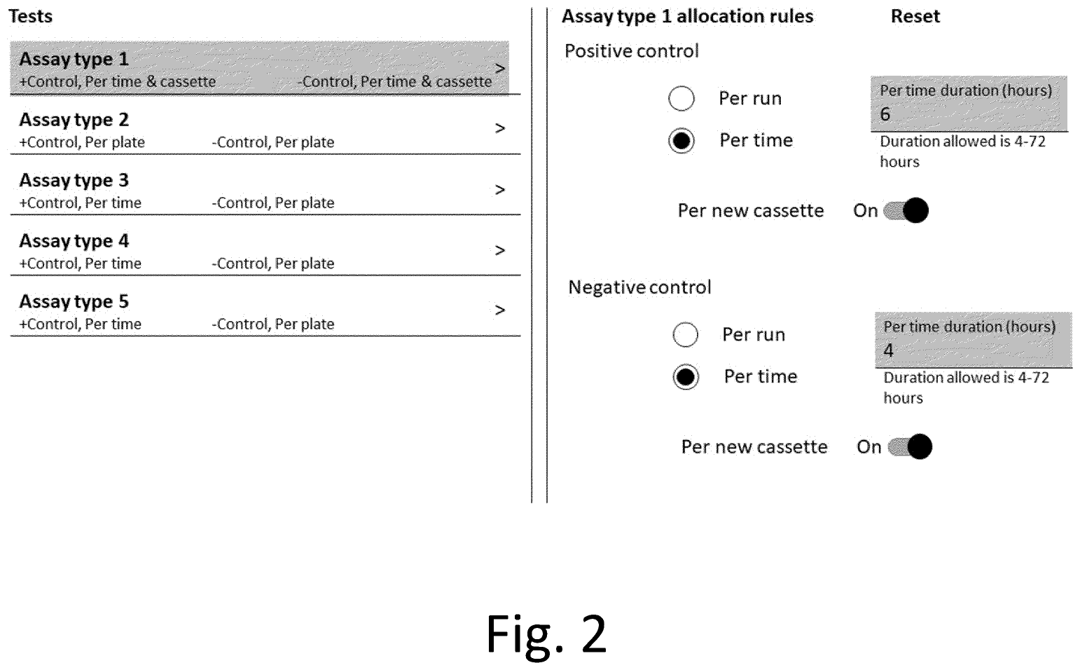

FIG. 2 shown a possible implementation of a GUI for determining the allocation rules for the control types associated with an assay type. In this case, the system or device has five different assay types that are available on the system or instrument. Assay type is selected, on the left side of the image provided to a user, an therefore, on the right side, a selection panel appears. A positive control type and a negative control type are associated with the assay type 1 selected. A user can then select independently for every control type, by ticking the correct box, if the allocation rule should comprise a time rule (per time) or a run rule (per run). In the case the user selects the box “per time”, then it is possible to select a time frame (“per time duration”, 6 hours in the case of the positive control and 4 in the case of the negative control). As may be seen from FIG. 2, the time frame can only accept a value between 4 h and 72 h (minimum and maximum time frame duration). In addition, the user can select for the control type if the allocation rule should also comprise instructions to run the control type for every reagent cartridge firstly used in the system or device (“per new cassette”). In FIG. 2, this is for both control types the case.

On the left side of the FIG. 2, it can also be seen that below every assay type, a short description of the actual allocation rules for every assay type is displayed. +Control stands for positive control type and −Control stands for negative control type.

As an example, the allocation rules associated with assay type 2 are that for both the positive and the negative control types they comprise a run rule (“per plate”). In the case of assay types 3, a and 5, the allocation rules are different for the positive control type (including only a time rule and no cartridge rule) and the negative control (including a run rule and no cartridge rule).

1. A method for increasing and optimizing controls handling in a laboratory system, the system comprising:
a control unit for controlling operation of the system,
a storage unit connected to the control unit and containing instructions, for each assay type, of the control type to be used when running said assay type, and, for each control type, an allocation rule for the control type,
the method comprising the following steps:
the control unit receiving at least one assay order comprising instructions to run at least one assay type on the system or device,
the control unit determining for the at least one assay type comprised in the at least one assay order, the control type to be used, and the corresponding allocation rule for said control type,
the control unit scheduling an assay run comprising instructions to include the determined control type based on the determined allocation rule, and
the control unit controlling the system to perform the scheduled assay run.

2. The method of claim 1, wherein the control type comprises at least one selected from a positive control type and a negative control type.

3. The method of claim 1, wherein the allocation rule comprises a time rule or a run rule, wherein
the time rule comprises at least instructions to run the control type once in a time frame, and
the run rule comprises instructions to run the control type:
once for every assay run, and/or
once for every reagent cartridge firstly used in the system or device, and/or
once for every reagent cartridge lot firstly used in the system or device.

4. The method of claim 3, wherein the time rule further comprises instructions to run the control type:
once for every assay run, and/or
once for every reagent cartridge firstly used in the system or device, and/or
once for every reagent cartridge lot firstly used in the system or device.

5. The method of claim 3 comprising:
determining, by the control unit, an estimated end time of the scheduled run,
determining, by the control unit, in a lifetime determination if the estimated end time of the scheduled run lies outside of the time frame of the time rule, and
if said lifetime determination is successful, rescheduling, by the control unit, the assay run comprising updated instructions to include the determined control type for which lifetime determination has been determined as successful.

6. The method of claim 3, wherein the time frame comprises a minimum time frame duration and a maximum time frame duration.

7. The method according to claim 6, wherein the maximum time frame duration and/or the minimum time frame duration is predetermined.

8. The method according to claim 1, further comprising receiving, by the control unit, an allocation rule over a user interface of the control unit.

9. A laboratory system, comprising:
a control unit for controlling operation of the system or device,
a storage unit connected to the control unit and containing instructions, for each assay type, of the control type to be used when running said assay type, and, for each control type, an allocation rule for the control type,
wherein the control unit is configured to:
receive at least one assay order comprising instructions to run at least one assay type on the system,
determine for the at least one assay type comprised in the at least one assay order, the control type to be used, and the corresponding allocation rule for said control type,
schedule an assay run comprising instructions to include the determined control type based on the determined allocation rule, and
control the system to perform the scheduled assay run.

10. The system of claim 9, wherein the control type comprises at least one selected from a positive control type and a negative control type.

11. The system of claim 9, wherein the allocation rule comprises a time rule or a run rule, wherein
the time rule comprises at least instructions to run the control type once in a time frame, and
the run rule comprises instructions to run the control type:
once for every assay run, and/or
once for every reagent cartridge firstly used in the system or device, and/or
once for every reagent cartridge lot firstly used in the system or device.

12. The system of claim 11, wherein the time rule further comprises instructions to run the control type:
once for every assay run, and/or
once for every reagent cartridge firstly used in the system or device, and/or
once for every reagent cartridge lot firstly used in the system or device.

13. The system of claim 11, wherein the control unit is further configured to:
determine an estimated end time of the scheduled run,
determine in a lifetime determination if the estimated end time of the scheduled run lies outside of the time frame of the time rule, and
if said lifetime determination is successful, to reschedule the assay run comprising updated instructions to include the determined control type for which lifetime determination has been determined as successful.

14. The system of claim 11, wherein the time frame comprises a minimum time frame duration and a maximum time frame duration.

15. The system according to claim 14, wherein the maximum time frame duration and/or the minimum time frame duration is predetermined.

16. The system according to claim 9, wherein control unit is further configured to receive an allocation rule over a user interface of the control unit.

17. A computer program product comprising instructions to cause a laboratory system to execute a method comprising the steps of:
receiving, at a control unit for controlling operation of the system, at least one assay order comprising instructions to run at least one assay type on the system;
determining, by the control unit, for the at least one assay type comprised in the at least one assay order, the control type to be used, and the corresponding allocation rule for said control type;
scheduling, by the control unit, an assay run comprising instructions to include the determined control type based on the determined allocation rule; and
controlling, by the control unit, the system to perform the scheduled assay run.

18. A non-transitory computer-readable storage medium having stored thereon the computer program product of claim 17.

19. The computer program product of claim 17, wherein the control type comprises at least one selected from a positive control type and a negative control type.

20. The computer program product of claim 17, wherein the method further comprises storing, in a memory, instructions, for each assay type, of the control type to be used when running said assay type, and, for each control type, an allocation rule for the control type, wherein the allocation rule comprises a time rule or a run rule, and wherein:
the time rule comprises at least instructions to run the control type once in a time frame, and
the run rule comprises instructions to run the control type:
once for every assay run, and/or
once for every reagent cartridge firstly used in the system, and/or
once for every reagent cartridge lot firstly used in the system.
